(19) United States
(12) Patent Application Publication
(10) Pub. No.: US 2006/0272621 A1
(43) Pub. Date: Dec. 7, 2006

(54) Cold air induction system, apparatus and method

(76) Inventors: Henry T. Acuna SR., Rockport, TX (US); Henry Acuna JR., Rockport, TX (US)

Correspondence Address: HENRY T. ACUNA, SR, 108 POQUITE DRIVE, ROCKPORT, TX, 78382, US

(21) Appl. No.: 11/144,981

(22) Filed: Jun. 3, 2005

(51) Int. Cl. F02M 31/20

(52) U.S. Cl. 123/542

(57) ABSTRACT

A cold air induction system, apparatus and method for effectuating a decrease in the air temperature entering the point of ignition in at least an internal combustion engine to increase the volume and efficiency of the air. The cold air induction system and apparatus comprises a cold air induction device wherein the device ingests ambient air and cools the air to a predetermined preset temperature. The cold air induction apparatus includes at least one housing having insulative capabilities for maintaining the cold air temperature created within the housing, wherein is housed a plurality of air cooling components and conduits for producing a cold air within the housing and distributing the cold air, wherein an expansion valve is provided for regulating the flow of refrigerant into the system. The system supplies the cold air to the throttle body by way of a forced source of cold air via an air cleaner.

### CROSS-REFERENCE TO RELATED APPLICATION

Not Applicable

### FIELD OF INVENTION

The present invention relates generally to improving performance of internal combustion engines.

### BACKGROUND OF INVENTION

The efficiency of an internal combustion engine is affected by many variables. The horsepower and torque available from a normally aspirated internal combustion engine are dependent upon the density of the air. Many common gases exhibit behavior very close to that of an ideal gas at ambient temperature and pressure. The ideal gas law equation, PV=nRT, was originally derived from the experimentally measured Charles' law and Boyle's law wherein P is the pressure of a gas, V the volume it occupies, n is the number of moles of gas present, R is the universal gas constant and T is its temperature (which must be in absolute temperature units, i.e., in Kelvin).

Under the relationship shown in the ideal gas equation above the association between the pressure, temperature, and volume of a gas indicates that if the gas is colder, it's denser, and denser air will provide more oxygen, allowing your car to burn more fuel and make more power because denser than normal air-fuel mixtures are more explosive when ignited, resulting in increased power. A common rule of thumb holds that decreasing air intake temperature by 10 degrees Fahrenheit (hereinafter “F” or designated by degrees) will increase horsepower and torque by 1%. The converse is also true; a 10 degree rise in intake temperature will cost you 1% of your horsepower.

In contrast, lower density air means less oxygen which leads to an increased fuel consumption and less power. Therefore, the composition of the mixture of air and fuel introduced into the combustion chambers of an internal combustion engine significantly affects performance. As such, motor vehicle engine power may be increased by providing a denser than normal air-fuel mixture to the point of ignition. However, to achieve optimum efficiency, the air/fuel mixture must be appropriately maintained at all levels of operation. To address consumer demand for greater engine power, particularly in internal combustion engines, turbo-chargers and superchargers were developed. Turbochargers and superchargers are devices which utilize mechanical means to increase the pressure of the air-fuel mixture before it enters the combustion chamber of the internal combustion engine. To increase air pressure, turbo-chargers and superchargers compress intake air. This increases the density of the air/fuel mixture, which leads to superior performance relative to naturally aspirated (atmospherically charged) engines. However, the use of a turbocharger or supercharger tends to increase the temperature of the air/fuel mixture during compression. This temperature increase degrades volumetric efficiency (i.e., air/fuel mixture per unit volume) by reducing the density of the air/fuel mixture being introduced into the combustion chamber.

A number of modifications and enhancements have been made to conventional internal combustion engines in an effort to improve performance. For example, it is well known that increasing the volume of air and fuel entering the combustion chambers will result in improved performance. Accordingly, to enhance power from an engine it is desirable to cool intake air, whether processed by a turbo-chargers, supercharger, or other devices, before the pressurized air is delivered to the point of ignition. On many cars, the first part of the intake tract the incoming air encounters is a tube designed to channel cold air from behind the grille or inside the fenderwell into the engine. Other cars lack this tube, and draw in hot air from under the hood. The air then passes into the air box or air cleaner containing an air filter to remove any incoming dirt, insects, and any other contaminants the air might have picked up off the road. The next object the air is likely to encounter is either the carburetor or, on fuel injected cars, the throttle body. Some engines will have multiple carburetors, or multiple throttle bodies. Either one typically contains a butterfly valve for controlling the amount of incoming air allowed into the engine. Carburetors and some throttle bodies will add fuel to the incoming air at this point, while multi-port fuel induction systems add the fuel at a point further downstream. The throttle body or carburetor is typically bolted onto a manifold for distributing the air to the individual cylinders.

A variety of heat exchangers has been developed to that attempt to assist in lowering air intake temperatures, including radiators in water-cooled engines, oil or oil bath coolers, intercoolers, and as indicated above, turbo-chargers and superchargers. Traditional heat exchangers transfer heat from a liquid coolant to the atmosphere; intercoolers, however, may also use a gas as the liquid, such as air, as a cooling medium. Intercoolers have been known to improve the efficiency and performance of turbocharged and supercharged engines for some time. The intercoolers that have been employed to date for these applications have been in a form that is an additional component to the engine, requiring modification to the engine and/or the turbocharger or supercharger. Therefore, devices have been utilized which introduce into the air/fuel mixture other liquids in an attempt to cool the mixture prior to combustion. There have also been attempts to provide cooling jackets surrounding the air passages through which the air flows prior to entering the combustion chambers.

In contrast to turbocharged and supercharged engines, naturally aspirated engines draw air directly from the area surrounding the air inlet and filter system. Efforts have been made to improve volumetric efficiency by positioning this air inlet in locations remote to the remainder of the engine. That is, it has been attempted to reduce the ambient temperature of the air being drawn into the combustion chamber by remotely locating the point at which atmospheric air is collected. Unfortunately, such efforts have yielded only modest gains in volumetric efficiency. What has been lacking, however, until the present invention, and what the industry long has sought, is a device that optimizes the temperature of an air-fuel mixture at the point of ignition so as to produce maximum horsepower, torque, fuel economy and fewer emissions and from an cold air-fuel combination.

Therefore, a previously unaddressed need exists in the industry for a new and useful cold air induction system, apparatus and method that is capable of delivering a continuous and/or on demand optimally cold air-fuel mixture for greater horsepower, torque, fuel economy and less emissions. Particularly, there is a significant need for a cold air induction system, apparatus and method that produces the lowest temperature of air possible for an air-fuel mixture into the throttle body at the point of ignition so as to produce maximum horsepower, torque, fuel economy and fewer emissions from an air-fuel charge.

### SUMMARY OF INVENTION

Given the need addressed above to solve problems associated with apparatuses for cooling air-fuel mixtures in motor vehicle engines, it would be desirable, and of considerable advantage, to provide a cold air induction system, apparatus and method that delivers optimally cooled air-fuel mixtures to achieve increased horsepower, torque, and fuel economy while simultaneously lowering emissions.

The novel cold air induction system, apparatus and method of the present invention provides numerous advantages over existing apparatus, advantages which are highly desired by the industry. At least one advantage of the present invention is that it decreases the temperature of the intake air entering through the throttle body of an internal combustion engine to significantly increase the volume and efficiency of the air. The system and apparatus combines an auxiliary air conditioning system Cold Air Induction device, hereinafter “CAI”, which intakes ambient air and cools the air to a predetermined preset temperature of at least fifty-five (55) degrees below the ambient temperature. The system and apparatus thereafter supplies the cold air at a temperature of at least fifteen (15) degrees below ambient temperature to the throttle body by way of a forced constant velocity source of cold air routed through an air cleaner device.

Another advantage of the present invention derives from the fact that the primary apparatus has the advantage of providing an enclosure in the form of a housing for the apparatus that is formed to direct cold air through the apparatus and system, the housing having insulative properties to assist in maintaining a cold air temperature therein the housing to minimize temperature increases of the cooled air prior to delivery of the cooled air to the throttle body point of ignition.

The cold air induction system and apparatus also comprises components, including an expansion valve, that contribute to controlling both the temperature of air and the flow of refrigerant for cooling the air from the apparatus to the point of ignition, thereby allowing delivery of the coldest air temperature possible at the desired point of ignition.

Another advantage of the present invention is its ability to cool air below ambient temperatures without using ice, ice water, antifreeze, or other substances currently utilized in connection with other apparatus seeking to achieve cooled air for an air-fuel mixture.

Another advantage of the present invention is its ability to significantly increase horsepower, torque and fuel economy all while simultaneously lowering emissions.

Still another advantage of the cold air induction system and apparatus is that it may deployed in any gasoline motor vehicle engine, whether naturally aspirated, turbo-charged, supercharged, or otherwise configured to cool air before directing the air to a point of ignition in the engine.

It will become apparent to one skilled in the art that the claimed subject matter as a whole, including the structure of the apparatus, and the cooperation of the elements of the apparatus, combine to result in the unexpected advantages and utilities of the present invention. The advantages and objects of the present invention and features of such a cold air induction system, apparatus and method will become apparent to those skilled in the art when read in conjunction with the accompanying description, drawing figures, and appended claims.

The foregoing has outlined broadly the more important features of the invention to better understand the detailed description that follows, and to better understand the contribution of the present invention to the art. As those skilled in the art will appreciate, the conception on which this disclosure is based readily may be used as a basis for designing other structures, methods, and systems for carrying out the purposes of the present invention. The claims, therefore, include such equivalent constructions to the extent the equivalent constructions do not depart from the spirit and scope of the present invention. Further, the abstract associated with this disclosure is neither intended to define the invention, which is measured by the claims, nor intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

It should be understood that any one of the features of the invention may be used separately or in combination with other features. It should be understood that features which have not been mentioned herein may be used in combination with one or more of the features mentioned herein. Other systems, methods, features, and advantages of the present invention will be or become apparent to one with skill in the art upon examination of the drawings and detailed description. It is intended that all such additional systems, methods, features, and advantages be included within this description, be within the scope of the present invention, and be protected by the accompanying claims.

These and other objects, features and advantages of the present invention will be more readily apparent when considered in connection with the following, detailed description of preferred embodiments of the invention, which description is presented in conjunction with annexed drawings below.

### BRIEF DESCRIPTION OF DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

The invention may take physical form in certain parts and arrangement of parts. For a more complete understanding of the present invention, and the advantages thereof, reference is now made to the following descriptions taken in conjunction with the accompanying drawings, in which:

FIG. 1 is a perspective view of the cold air induction system and apparatus installed in a motor vehicle for operation according to an embodiment of the present invention;

FIG. 2 is a top view of the cold air induction system and apparatus depicted in FIG. 1 according to the present invention; and

FIG. 3 is a schematic depiction of the supplemental air conditioner system line routing for an embodiment of the cold air induction system and apparatus installed in a motor vehicle according to the present invention.

### DETAILED DESCRIPTION OF THE PREFERRED EMBODIMENT

The following discussion is presented to enable a person skilled in the art to make and use the invention. The general principles described herein may be applied to embodiments and applications other than those detailed below without departing from the spirit and scope of the present invention as defined by the appended claims. The present invention is not intended to be limited to the embodiments shown, but is to be accorded the widest scope consistent with the principles and features disclosed herein.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative of but a few of the various ways in which the principles of the invention may be employed. Other objects, advantages and novel features of the invention will become apparent from the following detailed description of the invention when considered in conjunction with the drawings.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The present invention disclosed hereinbelow describes a cold air induction system and apparatus specifically designed to maintain a predetermined constant cold air temperature via an automatic thermostat controlled, or manual on demand, forced velocity of cold air to the throttle body of a motor vehicle via an air cleaner unit, wherein the cold air enters into the air cleaner unit in advance of the air cleaner filtration system. The air cleaner allows only 30% of ambient air to enter the original unit. Installation and use of the present invention's Cold Air Induction (“CAI”) system and apparatus increases efficiency by increasing horsepower and torque, lowering exhaust emissions, and significantly increasing fuel economy. For example, prior to installation of the CAI system the test vehicle (described below) averaged 11.3 miles per gallon (“MPG”). However, once installed in the test vehicle the fuel economy more than doubled to an average of at least 24.4 MPG.

The minimum motor vehicle specifications for use with the system and apparatus of the present invention comprise gasoline engine (e.g., engines from 4 cylinders to the 10 cylinder (“V-10”)) automobiles having year models of at least 1999 and newer including, but not limited to, passenger cars, pickup trucks, ½ ton to 1 ton commercial trucks, 1½ ton to 2 ton recreational motor homes with 8 cylinders (“V-8”) and V-10 gas engines. The year model restriction is due to the ability of newer automobiles' onboard computer compatibility related to compiling new engine readings and writing the improved efficiency (created by the present invention as described hereinbelow) to the (E-PROM) computer chip.

For description purposes of the operation and method of use of the present invention's system and apparatus the test automobile utilized, and referred to hereinbelow, was a 4 door 2003 Chevrolet 2500 HD Silverado pickup truck with a 6.01 engine, automatic transmission without overdrive having a rear axle ratio of 4.10 and a Gross Vehicle Weight Rating (“GVWR”) of over 8,600 lbs.

Heat is the enemy when it comes to engine horsepower. Today's Engine Control Units (“ECUs”) rely heavily on coolant temperatures when selecting fuel and timing maps. The ECU is especially sensitive to coolant temperatures when an engine is running hot. The ECU reacts by retarding the timing and richening of the mixture to avoid engine missing and/or knocking. This is due in part because hot spots on the engine sleeves can cause pre-ignition. Also, cooler Intake Air Temperatures (“IAT”) play an important role in reduced emissions and improved fuel economy. The benefits known to be attributed to cooler IATs are that cooler air comprises higher oxygen content and in response the ECUs on today's computerized motor vehicles will advance timing of the engine when the cooler IAT air is sensed, thereby allowing the engine to run leaner and as a result yield increased horsepower and performance.

The present invention, as will now be described in detail, provides for the desirable cooler IAT temperature readings via the CAI system and apparatus disclosed herein. The CAI system ingests ambient air and cools the ingested ambient air to a predetermined temperature of at least fifty-five (55) degrees below the ingested ambient temperature and then supplies cooled air having a temperature of at least fifteen (15) degrees below ambient temperature ultimately to the engine throttle body/point of ignition via a constant or on demand forced velocity of air, as will be further described in detail hereinbelow. The achieved result is a cooler engine temperature, reduced emissions and a substantially improved fuel economy having about twice the fuel economy of an automobile without the present invention installed. The CAI system and apparatus, in conjunction with the onboard vehicle computer, compensates for the changes in the IAT, engine coolant temperature (ECT), and the manifold absolute pressure (MAP) sensors which each work in unison for monitoring and logging the best efficiency and performance of the engine. Specifically, in brief, when the (CAI) system is installed, the onboard computer will monitor the new values from these sensors and the engines improved performance after an engine run period of 20 minutes “re-learn time” will take those values and write and save them to the E-PROM (memory) at which time these new values will become the minimum standard for engine operating specifications.

In tests involving recreational motor homes and commercial trucks, an average of only about 5-6 MPG was achieved when equipped with a V-10 gas engine. After installation of the CAI system, the fuel economy increased to at least 12-14 MPG. Such significant increases in fuel economy will have a tremendous impact on the cost of operation and emissions of today's recreational motor homes and commercial trucks.

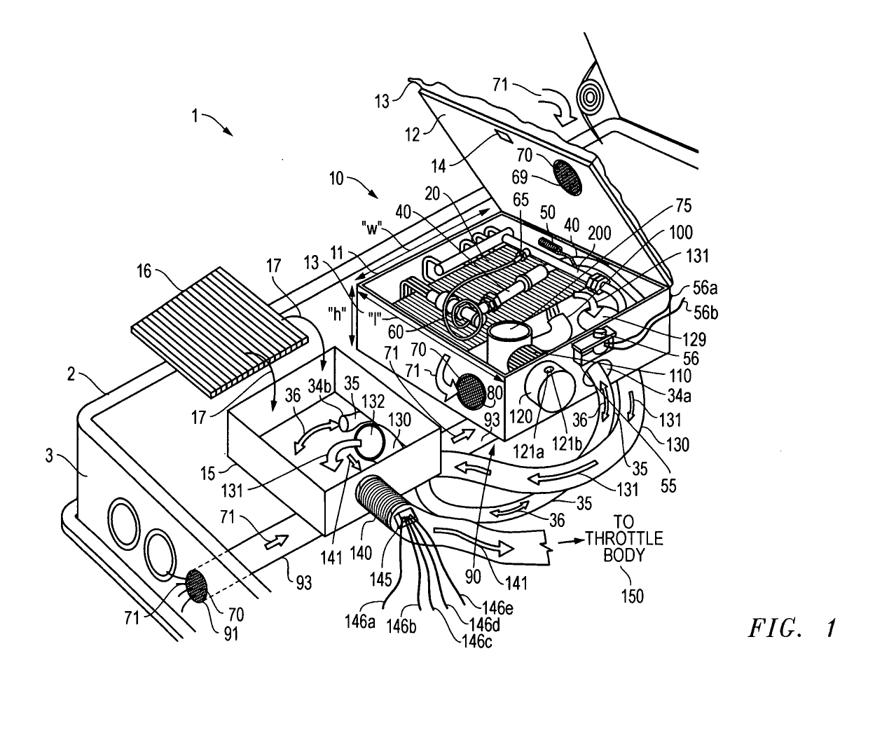

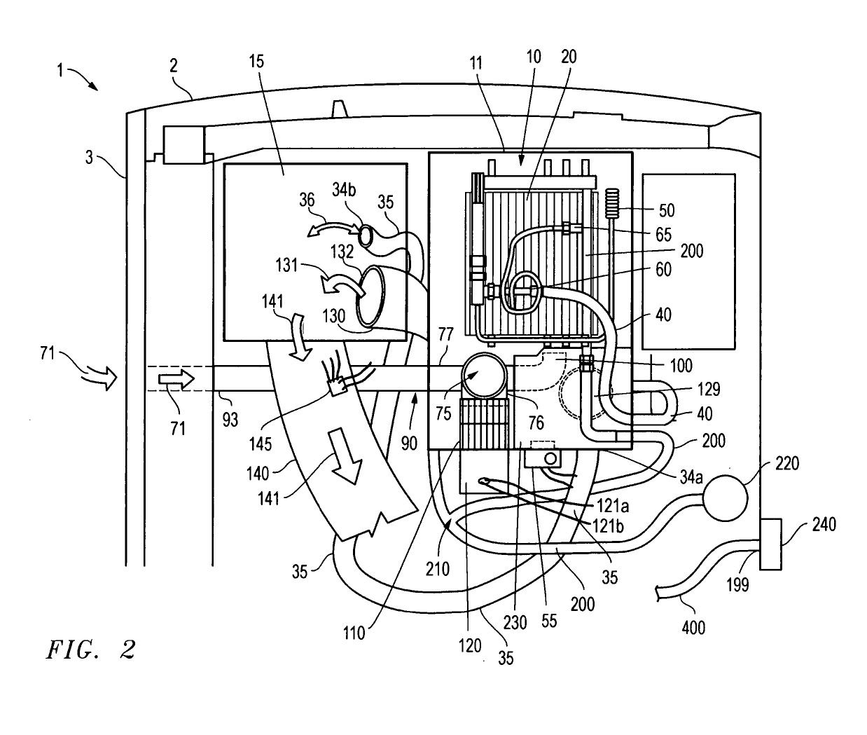

Now turning to FIGS. 1 through 3, specifically FIGS. 1 and 2, the present invention provides a cold air induction (CAI) system 1 comprising an air cooling unit 10 apparatus and method of using the same. The heart of the CAI system 1 of the present invention is the implementation of an auxiliary air conditioning evaporator cooling device 20 disposed within the air cooling unit 10, which will be described in operation hereinbelow for reducing the air temperature in the air-fuel mixture during the operation of an internal combustion engine.

As shown in FIGS. 1 and 2, the CAI system 1 comprises a fully insulated 13 cooling unit housing 11 for containing a plurality of components that make up the air cooling unit 10. The housing 11 can be constructed from any suitable sturdy and resilient substrate material having characteristic properties that assist in the prevention of interior housing heating and/or radiation of internally cooled air. The embodiment depicted in FIGS. 1 and 2 is of steel construction having a hinged top cover 12 with a swivel latch 14 for securement to ensure an air tight seal and insulated with a heat resistant material 13, whereby the insulated 13 hinged top cover 12 permits easy access to the internal components of the air cooling unit 10. The hinged top cover 12 is depicted in FIG. 1 as being partially hinged open for access. In operation, however, the hinged top cover 12 must be closed to achieve desired results. The dimensions of the housing 11 of the embodiment shown have a length “1” of about 16⅜ inches, a width “w” of about 12⅜ inches and a height “h” of about 6½ inches. However, it will be understood by one skilled in the art that the overall dimensions may be different for each motor vehicle application and also the size of the auxiliary air conditioning evaporator cooling device 20 employed.

The housing 11 is formed having at least three un-cooled ambient air ingestion inlet ports upper port 69, front port 80, and exterior front lower port 90 each positioned for ingesting ambient air 71 into the air cooling unit 10, at least one internal cooled ambient air ingestion port 100 and at least one primary forced pressure cold air exit port 129 and a secondary multidirectional cold air exit port 34a (34a shown in FIG. 1 from exterior side of housing 11 and in FIG. 2 from a top view of housing 11) each leading to an air cleaner/filter chamber 15, as will be further described in operational detail below. Un-cooled ambient air ingestion inlet ports 69, 80 are paired with a sized mated filter membrane 70 made from commonly used air filtration materials. The filter membranes 70 are removably positioned over the inlet ports 69, 80 to assist in filtration of incoming ambient air 71. It is readily seen in FIG. 2 that inlet 75 is in ambient air 71 flow communication with upper port 69 when lid 12 is in the closed position during operation. Furthermore, air ingestion inlet port 90 is removably engaged with a flexible and articulable conduit pipe 93 leading to a front automobile grille region 3, wherein the flexible and articulable conduit pipe 93 includes a distal end inlet 91 for permitting ingestion of ambient air 71 into un-cooled ambient air ingestion inlet port 90. Similar to inlet ports 69 and 80, the distal end inlet 91 is also paired with a sized mated filter membrane 70 as described above.

As can be more readily seen in FIG. 2, a hollow bore conduit 77 is disposed within the air cooling unit 10 for providing orifices for ambient air ingestion inlet ports 75, 80, 90 and 100 and ingested air egress blower fan port 76. The hollow bore conduit 77 in the present embodiment is constructed utilizing at least 2 inch diameter flexible conduit piping. However, without limitation, any suitable flexible conduit piping may be utilized for the hollow bore conduit 77 to achieve the desired flow communication with the ambient air ingestion inlet ports 69, 80, 90 and 100 and ingested air egress blower fan port 76 and blower fan 110 as depicted and described herein.

In continued reference to FIGS. 1 and 2, the auxiliary air conditioning evaporator cooling device 20 acts as a small radiator but instead of containing hot antifreeze it contains cold gas, R12 or R134 refrigerant. The cold gas passes through the auxiliary air conditioning evaporator cooling device 20 thus making it very cold. The air cooling unit 10 housing 11 has at least one blower fan 110 connected to a standard 12 volt blower fan motor 120. The blower fan 110 is disposed within the air cooling unit 10 mounted on a vertical side of the housing 11. The blower fan motor 120 utilized in the present embodiment was manufactured for 1987-1990 JEEP Wranglers and has a J.C. Whitney catalog order item number of ZX509233XF. The blower fan 110 is an AC Delco blower impeller having item #15-875.

An expansion valve 60 is disposed in communication with a modified air conditioner refrigerant line 40 (also known as a liquid line), wherein the expansion valve 60 is responsive to a temperature monitoring sensor probe 50 controlled by an adjustable thermostat 55 set by a temperature switch 56 for maintaining a predetermined temperature of at least fifty-five (55) degrees below ambient temperature within the air cooling unit 10. As mentioned above, insulative materials 13 completely surround the housing 11 to dissipate undesirable heat. The expansion valve regulates the flow of refrigerant gas, via the modified air conditioner refrigerant line 40, inside the auxiliary air conditioning evaporator cooling device 20. The temperature monitoring sensor probe 50 measures the ambient temperature at the auxiliary air conditioning evaporator cooling device 20 core near where the expansion valve 60 is located. The expansion valve 60 operates to open and close to meter the amount of refrigerant to the evaporator to regulate cooling. The present embodiment is capable of utilizing either R12 or R134 refrigerant but is not limited thereto. It is contemplated that one skilled in the art will understand that other refrigerants that may enter the market, or that may currently exist but are not listed herein, can be used and further remain within the scope and spirit of the disclosed invention described herein.

The blower fan 110, via an ingested air egress fan port 76 (shown in FIG. 2), is in a mixed air flow communication with un-cooled ambient air 71 and the internal cooling unit's 10 cooled air provided by way of at least the hollow bore conduit's 77 ingested air egress fan port 76. The blower fan 110 allows for ambient air 71 and internal cooled air movement throughout the air cooling unit 10 which causes any ingested un-cooled ambient air 71 from at least inlet ports 69, 80, 90 to be blown across the auxiliary air conditioning evaporator cooling device 20 to be cooled and to continuously cool previously ingested ambient air that has already been cooled by the cooling unit 10. In addition, the blower fan 110, controlled by the blower fan motor 120, whether in automatic or on-demand-by-user mode, allows the now cold air to be force blown as cold air 131 into at least a three inch diameter primary cold air channel 130 via a primary cold air exit port 129 (shown in FIG. 1) to travel via the primary cold air channel 130 to the air cleaner/filter chamber 15. The blower fan motor 120, in the manual on-demand-by-user mode, is connected via wires 121a, 121b to a switch (not shown) on the dash of the automobile for permitting the vehicle operator the option of activating the system 1.

As shown in FIGS. 1 and 2, after the cooled air 131 travels the circuit of the primary cold air channel 130, the cooled air 131 spills out into the air cleaner/filter chamber 15 via a filter chamber cold air orifice 132 prior to an installed standard air filter 16 mounted after 17 the incoming cooled air 131. What is also provided within the air cleaner/filter chamber 15 is a multidirectional cold air port 34b for providing a source of cooled air 36 from the air cooling unit 10.

In addition, the multidirectional cold air port 34b serves at least two purposes. For example, the multidirectional cold air port 34b, which is one end of a 1¼ inch diameter multipurpose air conduit 35 (such as a 1¼ diameter conduit) serves as a pressure line for a secondary supply of cold air coming into the air cleaner/filter chamber 15 (as described) and/or as a return air suction line, thereby defining its multidirectional capabilities. More specifically, for example, if the demand placed upon the engine by the operator increases (e.g., during acceleration to pass another vehicle etc.) the multidirectional cold air port 34b and multipurpose air conduit 35 may draw cold air from the air cooling unit 10 into the air cleaner/filter chamber 15 for introduction ultimately into the throttle body 150. In such a situation, both the multipurpose air conduit 35 and the primary cold air channel 130 provide cooled air 131, 36, respectively, to the air cleaner/filter chamber 15. On the other hand, if the engine is in a lower demand state, such as in idle, a pressure may build within the air cleaner/filter chamber 15. In this situation, the pressure can be released or lessened by the multidirectional cold air port 34b and multipurpose air conduit 35 allowing air to recirculate 36 from the air cleaner/filter chamber 15 back into the air cooling unit 10.

After the cooled air is received into the air cleaner/filter chamber 15 from the primary cold air channel 130 via the primary cold air exit port 129 and also, if under a demand by the engine via the multipurpose air conduit 35, via the multidirectional cold air port 34b air then travels through the air filter 16 for cleaning, which is installed within the air cleaner/filter chamber 15. Thereafter, the cooled/filtered air 141 enters into a pipe 140 and across a mass air flow (“MAF”) sensor 145 having wires 146a, 146b, 146c, 146d, and 146e for connection to the computer system of the vehicle. The MAF sensor 145 is used to determine the proper fuel/air mixture and is a sensitive piece of equipment that commonly incorporates a thin piece of wire that reads air intake and reports to the computer the current conditions such as, but not limited to, air temperature, air flow and actual volume of air ingested. After flowing across the MAF sensor 145 the cooled/filtered air 141 is forced to the throttle body 150 by way of the constant air velocity imposed by the blower fan 110, wherein the temperature of the forced cooled/filtered air 141 air entering the throttle body is now at least fifteen (15) degrees below the ingested ambient air 71 temperature.

With the system 1 of the present invention installed and engaged the auxiliary air conditioning evaporator cooling device 20 will maintain a constant preset temperature as described above utilizing the temperature monitoring sensor probe 50 and expansion valve 60 to effectively regulate the amount of refrigerant flow with the auxiliary air conditioning evaporator cooling device 20. In cold weather climates the blower motor 120 and blower fan 110 will be the only components of the system 1 engaged, thereby supplying to the throttle body 150 a constant forced velocity of cold air at the point of ignition. In the event the ambient air 71 within the air cooling unit 10 rises above the preset temperature described above, the system 1 will automatically engage the auxiliary air conditioning evaporator cooling device 20 and associated components to effectuate the cooling off process until at least the predetermined temperature is once again achieved.

Now turning to FIG. 2, what is shown is a top view of the system 1 as described above in relation to FIG. 1. The components and operation are the same, but the additional view is provided for clarity and relative situational positioning of the system 1 and its associated components. However, what is not depicted in FIG. 1 due to possible lack of clarity, but is included as a part of the air cooling unit 10 and is shown in FIG. 2 is an air deflection member 230 that functions as an air flow directional means to assist in effecting forced cooled air to enter at least the primary cold air channel 130 via the primary cold air exit port 129 as described above. Furthermore, what is not shown in FIG. 2, for sack of clarity but is included as a component in the embodiment, is filter 16.

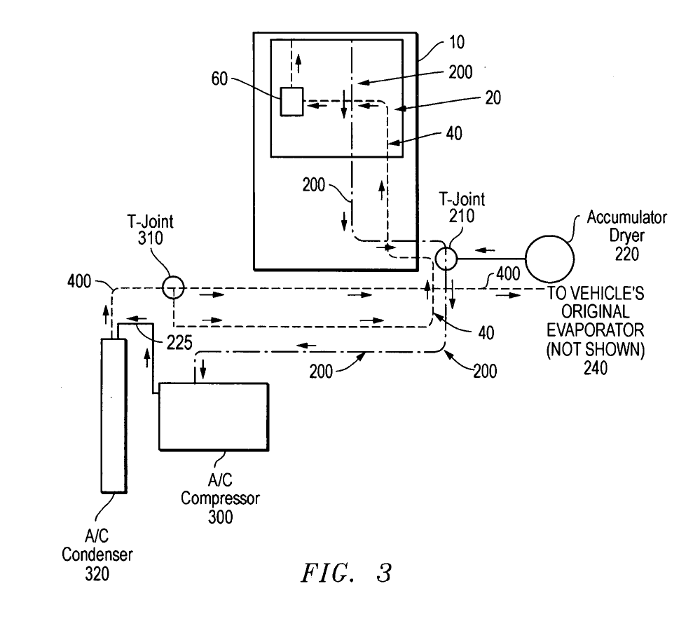

Furthermore, what is shown in FIG. 2, and with additional reference to FIG. 3, is a low pressure line 200 suction line connected at a first end 199 to the original air conditioning system's original accumulator/dryer unit 220 (also schematically shown in FIG. 3) of the automobile. The low pressure line 200 coming from the accumulator/dryer unit 220 branches via a first “T” joint 210 to flow into the automobile's original air conditioner compressor 300 (shown in FIG. 3).

Also shown in FIGS. 2 and 3 is the modified air conditioner refrigerant line 40 that allows refrigerant to flow from the condenser 320 via a second “T” joint 310 into the auxiliary air conditioning evaporator cooling device 20 as regulated by the expansion valve 60. The expansion valve 60 is shown in FIGS. 1 and 2 connected at one end to the auxiliary air conditioning evaporator cooling device 20 via the modified air conditioner refrigerant line 40 and at second end to the low pressure line 200 via connection 65. As will be described below in relation to FIG. 3, “T” joint 310 also permits a junction connection with the automobile's original liquid line 400 for connection and flow from the condenser 320 to the vehicle's original evaporator 240.

In further specific reference to FIG. 3 a schematic depiction of the system's 1 air conditioner line routing is shown in detail. FIG. 3 depicts the automobile's original accumulator/dryer 220 which is utilized for the separation of gas and liquid and also to remove any dirt and moisture. After departing the accumulator/dryer “T” joint 210 allows connection of the low pressure line 200 from the auxiliary air conditioning evaporator cooling device 20 and then to the automobile's original air conditioner compressor 300. After departing the compressor 300, pressure line 225 supplies the flow of refrigerant from the compressor 300 to the condenser 320 for conditioning. Although not shown in FIG. 2, “T” joint 310 allows refrigerant flow departing the condenser 320 to also be channeled to the vehicle's original evaporator 240.

Operational Summary

The following summary is not meant to be exclusive of any previously described process or components, but is intended to provide a basic application and understanding of how the system and apparatus of the present invention is operationally utilized.

In operation, the air cooling unit 10 is mounted adjacent a motor vehicle engine preferably in close proximity to the vehicle's air cleaner/filter chamber 15. Whenever the operator of the motor vehicle desires to increase fuel efficiency, horsepower and torque provided by the motor vehicle engine, the operator activates the switch mounted on the dash of the passenger compartment. Activation of the switch causes the initiation of the vehicle's cold air induction system 1, thereby allowing ambient air 71 to enter the air cooling unit 10 to be cooled by the enclosed auxiliary air conditioning evaporator cooling device 20 and temperature regulated wherein the expansion valve 60 is responsive to a temperature monitoring sensor probe 50 controlled by an adjustable thermostat 55 set by a temperature switch 56 for maintaining a predetermined temperature of at least fifty-five (55) degrees below ambient temperature within the air cooling unit 10. Thereafter, the blower fan 110 and blower motor 120 supply a constant forced velocity of cold air to the air cleaner/filter chamber 15 via primary cold air channel 130 via a primary cold air exit port 129 and/or the secondary multidirectional cold air exit port 34a and ultimately to the throttle body 150.

Test Data Summary

Presented below are a series of tests and their specific results. These tests were conducted with and without the CAI system 1 of the present invention installed on the test vehicle. In addition, tests were also conducted with the CAI system 1 installed and switched in both the ON and OFF positions. A Genisys (SPX/OTC) Diagnostic Computer was used for conducting and analyzing such tests on the test vehicle (as mentioned above the test vehicle was a 4 door 2003 Chevrolet 2500 HD Silverado pickup truck with a 6.01 engine, automatic transmission without overdrive having a rear axle ratio of 4.10 and a GVWR of over 8,600 lbs). The specific conditions for the tests conducted and computerized test results are as follows:

Abbreviations:

| Data Monitored: | Term Definition: |
|---|---|
| a. IAT temp | “IAT”—Intake Air Temperature |
| b. ECT sensor | “ECT”—Engine Control Temperature |
| c. Engine Load | |
| d. Long Term FT Bank 1 | |
| e. Long Term FT Bank 2 | |
| f.. MAF Sensor | “MAF”—Mass Air Flow |
| g.. MAP Sensor | “MAP”—Manifold absolute |
| | pressure |
| h.. Short Term FT Bank 1 | |
| i. Short Term FT Bank 2 | |
| j. Torque Request signal. | |
| (Note: not applicable | |
| on all tests) | |

TEST 1
Category: Miss fire data

1. Miss fire shows no miss fire on the 6.0 L engine being tested.
2. The miss fire test is important to ascertain if the engine is in optimal
running condition with no miss fires present on any cylinders.

| | | |
|---|---|---|
| Engine Speed | 2272 | RPM |
| Vehicle Speed Sensor | 65 | MPH |
| Spark | 30 | deg |
| A/C Relay Command | On | |
| ECT Sensor | 194 | degrees F. |
| Engine Load | 22 | % |
| Engine Run Time | 1810.00 | sec |
| Injector PWM Bk 1 Avg | 8.51 | msec |
| Injector PWM Bk 2 Avg | 8.36 | msec |
| MAF Sensor | 63.03 | g/s |
| MAP Sensor | 9 | PSI |
| Misfire Cntr Status | Normal | |
| Misfire Current Cyl 1 | 0 | |
| Misfire Current Cyl 2 | 0 | |
| Misfire Current Cyl 3 | 0 | |
| Misfire Current Cyl 4 | 0 | |
| Misfire Current Cyl 5 | 0 | |
| Misfire Current Cyl 6 | 0 | |
| Misfire Current Cyl 7 | 0 | |
| Misfire Current Cyl 8 | 0 | |
| Misfire Data Cycles | 30 | |
| Misfire History Cyl 1 | 0 | |
| Misfire History Cyl 2 | 0 | |
| Misfire History Cyl 3 | 0 | |
| Misfire History Cyl 4 | 0 | |
| Misfire History Cyl 5 | 0 | |
| Misfire History Cyl 6 | 0 | |
| Misfire History Cyl 7 | 0 | |
| Misfire History Cyl 8 | 0 | |
| TCC Enable Sol Comd | On | |
| TP Angle | 31% | |

TEST 2
CAI system Not Installed.
Category: Diagnostic Status (live).

1. Test on 2003 Chevrolet pickup truck.
IAT temp 97 degrees
ECT Sensor 198 degrees
Engine Load: 20%
Long Term FT Bank 1: 2.3%
Long Term FT Bank 2: 2.3%
MAF Sensor: 56.57 g/s
Short Term FT Bank 1: 3.1
Short Term FT Bank 2: −2.3%

| | | |
|---|---|---|
| TP Desired Angle | 30 | % |
| Engine Speed | 2436 | RPM |
| Intake Air Temp | 97 | degrees F. |
| HO2S Bank 1 Sensor 1 | 113 | mV |
| Vehicle Speed Sensor | 69 | MPH |
| Spark | 25 | deg |
| A/C Relay Command | Off | |
| Barometric Press. | 14 | PSI |
| Cruise Control Active | Yes | |
| Crus Inhbt Sig Cmd | Off | |
| Current Gear | 4 | |
| DTC Set This Ign Cycl | No | |
| Desired IAC Airflow | 28.45 | g/s |
| Desired Idle Speed | 575 | RPM |
| ECT Sensor | 198 | degrees F. |
| EVAP Purge Sol | 100 | % |
| EVAP Vent Sol Comd | Venting | |
| Engine Load | 20 | % |
| Engine Run Time | 1570.00 | sec |
| Fuel Level Sen Rear | 4.94 | V |
| Fuel Level Sensor | 2.51 | V |
| Fuel Tank Press Sen | −7.28 | inH2O |
| Fuel Trim Cell (BLM) | 11 | |
| Fuel Trim Learn | Enabled | |
| HO2S Bank 1 Sensor 2 | 738 | mV |
| HO2S Bank 2 Sensor 1 | 751 | mV |
| HO2S Bank 2 Sensor 2 | 734 | mV |
| Ignition 1 Signal | 13.6 | V |
| Knock Retard | 0.0 | deg |
| Long Term FT Bank 1 | 2.3 | % |
| Long Term FT Bank 2 | 2.3 | % |
| Loop Status | Closed | |
| MAF Sensor | 56.57 | g/s |
| MAP Sensor | 2.37 | V |
| MAP Sensor | 8 | PSI |
| PCM Reset | No | |
| Power Enrichment | Inactive | |
| Reduced Engine Power | Inactive | |
| Short Term FT Bank 1 | 3.1 | % |
| Short Term FT Bank 2 | −2.3 | % |
| TCC Enable Sol Comd | On | |
| TP Angle | 30 | % |
| VTD Auto Learn Timer | Inactive | |
| VTD Fail Enable | No | |
| VTD Fuel Disable | Inactive | |
| VTD Fuel Dsble Ign Off | No | |

TEST 3
CAI Installed
Category: Diagnostic Status (live):

1. Test on 2003 Chevrolet pickup truck.
IAT temp 84 degrees
ECT Sensor 196 degrees
Engine Load: 20%
Long Term FT Bank 1: −0.8%
Long Term FT Bank 2: 0.0%
MAF Sensor: 56.97 g/s
Short Term FT Bank 1: −1.6%
Short Term FT Bank 2: −5.5%

| | | |
|---|---|---|
| Engine Speed | 2270 | RPM |
| Intake Air Temp | 81 | degrees F. |
| HO2S Bank Sensor 1 | 781 | mV |
| Vehicle Speed Sensor | 65 | MPH |
| Spark | 31 | deg |
| A/C Relay Command | On | |
| Accel Ped Pos Ind Ang | 0 | % |
| Barometric Press. | 15 | PSI |
| Cruise Control Active | Yes | |
| Crus Inhbt Sig Cmd | Off | |
| Current Gear | 4 | |
| DTC Set This Ign Cycl | No | |
| Desired IAC Airflow | 29.47 | g/s |
| Desired Idle Speed | 575 | RPM |
| ECT Sensor | 196 | degrees F. |
| EVAP Purge Sol | 100 | % |
| EVAP Vent Sol Comd | Venting | |
| Engine Load | 20 | % |
| Engine Run Time | 909.00 | sec |
| Fuel Level Sen Rear | 4.94 | V |
| Fuel Level Sensor | 2.51 | V |
| Fuel Tank Press Sen | −7.28 | inH2O |
| Fuel Trim Cell (BLM) | 7 | |
| Fuel Trim Learn | Enabled | |
| HO2S Bank 1 Sensor 2 | 707 | mV |
| HO2S Bank 2 Sensor 1 | 747 | mV |
| HO2S Bank 2 Sensor 2 | 686 | mV |
| Ignition 1 Signal | 13.5 | V |
| Knock Retard | 0.0 | deg |
| Long Term FT Bank 1 | −0.8 | % |
| Long Term FT Bank 2 | 0.0 | % |
| Loop Status | Closed | |
| MAF Sensor | 56.97 | g/s |
| MAP Sensor | 2.42 | V |
| MAP Sensor | 8 | PSI |
| PCM Reset | No | |
| Power Enrichment | Inactive | |
| Reduced Engine Power | Inactive | |
| Short Term FT Bank 1 | −1.6 | % |
| Short Term FT Bank 2 | −5.5 | % |
| TCC Enable Sol Comd | On | |
| TP Angle | 29 | % |
| TP Desired Angle | 29 | % |
| VTD Auto Learn Timer | Inactive | |
| VTD Fail Enable | No | |
| VTD Fuel Disable | Inactive | |
| VTD Fuel Dsble Ign Off | No | |

TEST 4
CAI Not Installed
Category: Diagnostic Status (live)

1. Test on 2003 Chevrolet pickup truck.
IAT temp 104 degrees
ECT Sensor 203 degrees
Engine Load: 21%
Long Term FT Bank 1: 1.6%
Long Term FT Bank 2: 2.3%
MAF Sensor: 46.07 g/s
Short Term FT Bank 1: 5.5%
Short Term FT Bank 2: −1.6%
Torque Delivered Signal: 87 ft-lbs

| | | |
|---|---|---|
| Engine Speed | 2068 | RPM |
| Intake Air Temp | 104 | degrees F. |
| Vehicle Speed Sensor | 59 | MPH |
| Spark | 30 | deg |
| 4WD Low Signal | Disabled | |
| 4WD Signal | Disabled | |
| A/C Pressure Sensor | 1.90 | V |
| A/C Pressure Sensor | 172 | PSI |
| A/C Relay Command | On | |
| A/C Request Signal | Yes | |
| Accel Ped Pos Ind Ang | 32 | % |
| CMP Sensor Hi To Low | 39998 | |
| CMP Sensor Low to Hi | 39997 | |
| Coolant Level Switch | Ok | |
| Current Gear | 4 | |
| Desired Idle Speed | 575 | RPM |
| ECT Sensor | 203 | degrees F. |
| Engine Load | 21 | % |
| Engine Oil Level Sw | Ok | |
| GEN F-Terminal Signal | 8 | % |
| GEN L-Terminal Signal | On | |
| Ignition 1 Signal | 13.5 | V |
| Injector PWM Bk 1 Avg | 7.29 | msec |
| Injector PWM Bk 2 Avg | 7.29 | msec |
| Long Term FT Bank 1 | 1.6 | % |
| Long Term FT Bank 2 | 2.3 | % |
| Loop Status | Closed | |
| Low Oil Lamp Comd | Off | |
| MAF Sensor | 46.07 | g/s |
| MAF Sensor | 5688.5 | Hz |
| MAP Sensor | 2.89 | V |
| MAP Sensor | 9 | PSI |
| MIL Command | Off | |
| PCM Reset | No | |
| Short Term FT Bank 1 | 5.5 | % |
| Short Term FT Bank 2 | −1.6 | % |
| Start Up Coolant | −212 | degrees F. |
| TCC Enable Sol Cmd | On | |
| TCC PWM Solenoid | On | |
| TFP Switch | Drive 4 | |
| TP Angle | 28 | % |
| TP Desired Angle | 28 | % |
| Torque Delivered Sig | 87 | ft-lbs |
| Torque Request Signal | 256 | ft-lbs |
| Traction Ctrl Sig | Inactive | |
| Trans Range Switch | Drive 4 | |

TEST 5
CAI Installed
Category: Diagnostic Status (live)

1. Test on 2003 Chevrolet pickup truck.
IAT temp 82 degrees
ECT Sensor 194 degrees
Engine Load: 18%
Long Term FT Bank 1: −0.8%
Long Term FT Bank 2: −1.6%
MAF Sensor: 51.40 g/s
Short Term FT Bank 1: −2.3%
Short Term FT Bank 2: −2.3%
Torque Delivered Signal: 103 ft-lbs

| | | |
|---|---|---|
| Engine Speed | 2110 | RPM |
| Intake Air Temp | 82 | degrees F. |
| Vehicle Speed Sensor | 60 | MPH |
| Spark | 30 | deg |
| 4WD Low Signal | Disabled | |
| 4WD Signal | Disabled | |
| A/C Pressure Sensor | 2.24 | V |
| A/C Pressure Sensor | 202 | PSI |
| A/C Relay Command | On | |
| A/C Request Signal | Yes | |
| Accel Ped Pos Ind Ang | 32 | % |
| CMP Sensor Hi to Low | 48766 | |
| CMP Sensor Low to Hi | 48766 | |
| Coolant Level Switch | Ok | |
| Current Gear | 4 | |
| Desired Idle Speed | 575 | RPM |
| ECT Sensor | 194 | degrees F. |
| Engine Load | 18 | % |
| Engine Oil Level Sw | Ok | |
| GEN F-Terminal Signal | 8 | % |
| GEN L-Terminal Signal | On | |
| Ignition 1 Signal | 13.5 | V |
| Injector PWM Bk 1 Avg | 8.13 | msec |
| Injector PWM Bk 2 Avg | 7.98 | msec |
| Long Term FT Bank 1 | −0.8 | % |
| Long Term FT Bank 2 | −1.6 | % |
| Loop Status | Closed | |
| Low Oil Lamp Comd | Off | |
| MAF Sensor | 51.40 | g/s |
| MAF Sensor | 5852.1 | Hz |
| MAP Sensor | 2.47 | V |
| MAP Sensor | 8 | PSI |
| MIL Command | Off | |
| PCM Reset | No | |
| Short Term FT Bank 1 | 2.3 | % |
| Short Term FT Bank 2 | 2.3 | % |
| Start Up Coolant | 208 | degrees F. |
| TCC Enable Sol Comd | On | |
| TCC PWM Solenoid | On | |
| TFP Switch | Drive 4 | |
| TP Angle | 28 | % |
| TP Desired Angle | 28 | % |
| Torque Delivered Sig | 103 | ft-lbs |
| Torque Request Signal | 256 | ft-lbs |
| Traction Ctrl Sig | Inactive | |
| Trans Range Switch | Drive 4 | |

TEST 6
CAI installed but turned OFF:
Category: Diagnostic Status (live
Truck parked in idle for approximately 15 minutes.
Note: IAT temperature increased to 91 degrees in 5 minutes.)

1. Test on 2003 Chevrolet pickup truck.
IAT temp 91 degrees
ECT Sensor 1 96 degrees
Engine Load: 2% (Idle and parked)
Long Term FT Bank 1: −1.6%
Long Term FT Bank 2: −1.6%
MAF Sensor: 6.22 g/s
Short Term FT Bank 1: 1.6%
Short Term FT Bank 2: 0.8%

| | | |
|---|---|---|
| MAF Sensor | 6.22 | g/s |
| ECT Sensor | 196 | degrees F. |
| Fuel Level Remaining | 26.0 | ga |
| Short Term FT Bank 2 | 0.8 | % |
| Short Term FT Bank 1 | 1.6 | % |
| Engine Speed | 573 | RPM |
| Intake Air Temp | 91 | degrees F. |
| HO2S Bank 1 Sensor | 738 | mV |
| Vehicle Speed Sensor | 0 | MPH |
| Accel Ped Pos Ind Ang | 0 | % |
| Barometric Press. | 15 | PSI |
| DTC Set This Ign Cycl | No | |
| Desired Idle Speed | 575 | RPM |
| EVAP Purge Sol | 20 | % |
| EVAP Vent Sol Comd | Venting | |
| Engine Load | 2 | % |
| Engine Run Time | 6532.00 | sec |
| Fuel Level Sen Rear | 4.94 | V |
| Fuel Level Sensor | 2.51 | V |
| Fuel Tank Press Sen | 0.02 | V |
| Fuel Tank Press Sen | −7.28 | inH2O |
| Fuel Tank Rate Cap | 25.9 | ga |
| Fuel Trim Cell (BLM) | 17 | |
| Fuel Trim Learn | Enabled | |
| HO2S Bank 2 Sensor 1 | 703 | mV |
| Ignition 1 Signal | 13.6 | V |
| Long Term FT Bank 1 | −1.6 | % |
| Long Term FT Bank 2 | −1.6 | % |
| Loop Status | Closed | |
| MAP Sensor | 5 | PSI |
| PCM Reset | No | |
| Start Up Coolant | 212 | degrees F. |
| TP Angle | 10 | % |
| Tp Desired Angle | 10 | % |

TEST 7
CAI Installed and turned ON
Truck parked in idle for approximately 15 minutes.
Category: Diagnostic Status (live)

1. Test on 2003 Chevrolet pickup truck.
IAT temp 68 degrees
ECT Sensor 192 degrees
Engine Load: 2%
Long Term FT Bank 1: 0.0%
Long Term FT Bank 2: −0.8%
MAF Sensor: 5.96 g/s
Short Term FT Bank 1: 1.6%
Short Term FT Bank 2: 0.0%

| | | |
|---|---|---|
| MAF Sensor | 5.96 | g/s |
| ECT Sensor | 192 | degrees F. |
| Fuel Level Remaining | 21.3 | ga |
| Short Term FT Bank 2 | 1.6 | % |
| Short Term FT Bank 1 | 0.0 | % |
| Engine Speed | 544 | RPM |
| Intake Air Temp | 68 | degrees F. |
| HO2S Bank 1 Sensor 1 | 113 | mV |
| Vehicle Speed Sensor | 0 | MPH |
| Accel Ped Pos Ind Ang | 0 | % |
| Barometric Press. | 15 | PSI |
| DTC Set This Ign Cycl | No | |
| Desired Idle Speed | 575 | RPM |
| EVAP Purge Sol | 20 | % |
| EVAP Vent Sol Comd | Venting | |
| Engine Load | 2 | % |
| Engine Run Time | 3863.00 | sec |
| Fuel Level Sen Rear | 4.94 | V |
| Fuel Level Sensor | 2.35 | V |
| Fuel Tank Press Sen | 0.02 | V |
| Fuel Tank Press Sen | −7.28 | inH2O |
| Fuel Tank Rate Cap | 25.9 | ga |
| Fuel Trim Cell (BLM) | 19 | |
| Fuel Trim Learn | Enabled | |
| HO2S Bank 2 Sensor 1 | 534 | mV |
| Ignition 1 Signal | 13.9 | V |
| Long Term FT Bank 1 | 0.0 | % |
| Long Term FT Bank 2 | −0.8 | % |
| Loop Status | Closed | |
| MAP Sensor | 6 | PSI |
| PCM Reset | No | |
| Start Up Coolant | 212 | degrees F. |
| TP Angle | 9 | % |
| TP Desired Angle | 10 | % |

TEST 8
CAI not installed
Category: Diagnostic Status (live)
Truck parked with engine @ 2172 rpm for 15 minutes.

1. Test on 2003 Chevrolet pickup truck.
IAT temp 124 degrees
ECT Sensor 199 degrees
Engine Load: 8%
Long Term FT Bank 1: 1.6%
Long Term FT Bank 2: 2.3%
MAF Sensor: 22.77 g/s
Short Term FT Bank 1: 4.7%
Short Term FT Bank 2: 3.1

| | | |
|---|---|---|
| MAF Sensor | 4424.3 | Hz |
| MAP Sensor | 0.99 | V |
| MAP Sensor | 4 | PSI |
| Intake Air Temp | 124 | degrees F. |
| A/C Pressure Sensor | 251 | PSI |
| Short Term FT Bank 2 | 4.7 | % |
| Short Term FT Bank 1 | 3.1 | % |
| ECT Sensor | 199 | degrees F. |
| MAF Sensor | 22.77 | g/s |
| Engine Speed | 2172 | RPM |
| Vehicle Speed Sensor | 0 | MPH |
| Spark | 43 | deg |
| 4WD Low Signal | Disabled | |
| 4WD Signal | Disabled | |
| A/C Pressure Sensor | 2.78 | V |
| A/C Relay Command | On | |
| A/C Request Signal | Yes | |
| Accel Ped Pos Ind Ang | 17 | |
| CMP Sensor Hi to Low | 37167 | |
| CMP Sensor Low to Hi | 37165 | |
| Coolant Level Switch | Ok | |
| Current Gear | 1 | |
| Desired Idle Speed | 575 | RPM |
| Engine Load | 8 | % |
| Engine Oil Level Sw | Ok | |
| GEN F-Terminal Signal | 9 | % |
| GEN L-Terminal Signal | On | |
| Ignition 1 Signal | 13.5 | V |
| Injector PWM Bk 1 Avg | 3.74 | msec |
| Injector PWM Bk 2 Avg | 3.59 | msec |
| Long Term FT Bank 1 | 1.6 | % |
| Long Term FT Bank 2 | 2.3 | % |
| Loop Status | Closed | |
| Low Oil Lamp Comd | Off | |
| MIL Command | Off | |
| PCM Reset | No | |
| Start Up Coolant | 70 | degrees F. |
| TCC Enable Sol Comd | Off | |
| TCC PWM Solenoid | Off | |
| TFP Switch | Park/Neut | |
| TP Angle | 20 | % |
| TP Desired Angle | 20 | % |
| Torque Delivered Sig | 12 | ft-lbs |
| Torque Request Signal | 256 | ft-lbs |
| Traction Ctrl Sign | Inactive | |
| Trans Range Switch | Park | |

TEST 9
CAI installed.
Category: Diagnostic Status (live)
Truck parked with engine at 2238 rpm for 15 minutes.

1. Test on 2003 Chevrolet pickup truck.
IAT temp 90 degrees
ECT Sensor 198 degrees
Engine Load: 8%
Long Term FT Bank 1: 1.6%
Long Term FT Bank 2: 1.6%
MAF Sensor: 23.99 g/s
Short Term FT Bank 1: 0.0%
Short Term FT Bank 2: 5.5%

| | | |
|---|---|---|
| MAF Sensor | 4500.0 | Hz |
| MAP Sensor | 0.99 | V |
| MAP Sensor | 4 | PSI |
| Intake Air Temp | 90 | degrees F. |
| A/C Pressure Sensor | 253 | PSI |
| Short Term FT Bank 2 | 0.0 | % |
| Short Term FT Bank 1 | 5.5 | % |
| ECT Sensor | 198 | degrees F. |
| MAF Sensor | 23.99 | g/s |
| Engine Speed | 2238 | RPM |
| Vehicle Speed Sensor | 0 | MPH |
| Spark | 43 | deg |
| 4WD Low Signal | Disabled | |
| 4WD Signal | Disabled | |
| A/C Pressure Sensor | 2.80 | V |
| A/C Relay Command | On | |
| A/C Request Signal | Yes | |
| Accel Ped Pos Ind Ang | 18 | % |
| CMP Sensor Hi to Low | 29213 | |
| CMP Sensor Low to Hi | 29212 | |
| Coolant Level Switch | Ok | |
| Current Gear | 1 | |
| Desired Idle Speed | 575 | RPM |
| Engine Load | 8 | % |
| Engine Oil Level Sw | Ok | |
| GEN F-Terminal Signal | 13 | % |
| GEN L-Terminal Signal | On | |
| Ignition 1 Signal | 13.5 | V |
| Injector PWM Bk 1 Avg | 3.66 | msec |
| Injector PWM Bk 2 Avg | 3.89 | msec |
| Long Term FT Bank 1 | 1.6 | % |
| Long Term FT Bank 2 | 1.6 | % |
| Loop Status | Closed | |
| Low Oil Lamp Comd | Off | |
| MIL Command | Off | |
| PCM Reset | No | |
| Start Up Coolant | 70 | degrees F |
| TCC Enable Sol Comd | Off | |
| TCC PWM Solenoid | Off | |
| TFP Switch | Park/Neut | |
| TP Angle | 20 | % |
| TP Desired Angle | 20 | % |
| Torque Delivered Sig | 16 | ft-lbs |
| Torque Request Signal | 256 | ft-lbs |
| Traction Ctrl Sig | Inactive | |
| Trans Range Switch | Park | |

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. It is therefore, contemplated that the claims will cover any such modifications or embodiments that fall within the true scope of the invention.

What is claimed is:

1. A cold air induction system for providing a constant flow of cooled air to the point of ignition in a gas engine of a vehicle, the system utilizing an originally installed standard air conditioning compressor, air conditioning condenser and accumulator/dryer of the vehicle to complement the system, the system comprising:
a gas engine;
a cold air induction apparatus housing comprising a plurality of ambient air ingestion inlets and components for cooling the ingested ambient air prior to introduction into the gas engine;
an auxiliary air conditioning evaporator cooling device disposed within the housing for cooling the ingested ambient air to a predetermined temperature;
a temperature monitoring sensor probe in communication with an adjustable thermostat device, wherein the probe and thermostat device cooperatively operate with the auxiliary air conditioning evaporator cooling device to maintain the ingested ambient air within the housing at a predetermined temperature in communication;
a fan for forcefully dispersing and distributing the ingested ambient air over the cooling device, the sensor probe and throughout the system;
a primary cold air port and a secondary multidirectional cold air port disposed thereon a portion of the housing and in flow communication with the forced air flow produced by the fan; and
an air cleaner chamber comprising a filter for filtering the cooled air distributed from the primary cold air port and the secondary multidirectional cold air port, wherein the filter is disposed within the chamber in a situational relationship so as to filter the air introduced into the chamber prior to introduction into the point of ignition on the engine.

2. The system as in claim 1 wherein the ingested ambient air in funneled into the housing by way of a hollow bore conduit, wherein the hollow bore conduit is in flow communication with at least the plurality of ambient air ingestion inlets.

3. The system as in claim 2 wherein the plurality of un-cooled ambient air ingestion ports comprise a removably attached mated filter membrane.

4. The system as in claim 3 wherein the plurality of un-cooled ambient air ingestion ports comprise an upper port, a front port and an exterior lower front port.

5. The system as in claim 4 wherein the exterior lower front port is removably engaged with a flexible and articulable conduit pipe leading to a front region of the vehicle.

6. The system as in claim 1 wherein the auxiliary air conditioning evaporator cooling device is in flow communication with a modified air conditioner refrigerant the modified air conditioner refrigerant line having a T joint for connection to the accumulator/dryer and the air conditioner compressor.

7. The system as in claim 6 wherein the modified air conditioner refrigerant line is in flow communication with a low pressure line, wherein the low pressure line comprises a T joint for connection with the air conditioner compressor and vehicle's original evaporator.

8. The system as in claim 6 wherein the temperature monitoring sensor probe is in communication with at least to the modified air conditioner refrigerant line and the auxiliary air conditioning evaporator cooling device.

9. The system as in claim 2 wherein the ingested ambient air is funneled within the housing to at least the fan through the hollow bore conduit.

10. The system as in claim 1 wherein the primary cold air port and the secondary multidirectional cold air port provides for removable attachment to a plurality of cold air conduits, wherein the cold air conduits allow delivery of the cooled air to/from the housing.

11. The system as in claim 10 wherein the secondary multidirectional cold air port provides for delivery of cold air from the housing to the air cleaner chamber and further allows for air within the chamber to be extracted back into the housing from the chamber when the engine is not under a load demand condition, thereby allowing the extracted air to be further re-cooled and re-delivered to the chamber.

12. A cold air induction apparatus for cooling ingested ambient air prior to introduction to the point of ignition in a gas engine of a vehicle, the apparatus utilizing an originally installed standard air conditioning compressor, air conditioning condenser and accumulator/dryer of the vehicle to complement the apparatus, the apparatus comprising:
a housing comprising a plurality of ambient air ingestion inlets and components for cooling the ingested ambient air prior to introduction into the gas engine;
a plurality of air ports, wherein a plurality of conduits are removably attached thereto at the plurality of air ports;
an auxiliary air conditioning evaporator cooling device disposed within the housing, wherein the plurality of air ports are in air flow communication with the auxiliary air conditioning evaporator cooling device;
a temperature monitoring sensor probe in communication with an adjustable thermostat device, wherein the probe and thermostat device cooperatively operate to maintain the ingested ambient air within the housing at a predetermined temperature;
a fan for forcefully dispersing and distributing the ingested ambient air throughout the system; and
a primary and a secondary cold air exit port disposed thereon a portion of the housing for providing cold air conduits for distribution of the cooled air.

13. The apparatus as in claim 12 wherein the housing is constructed of steel.

14. The apparatus as in claim 13 wherein the steel housing is fully covered on the exterior with an insulative material.

15. The apparatus as in claim 12 wherein the housing is so dimensioned to accommodate a desired engine compartment and specific desired size of auxiliary air conditioning evaporator cooling device selected.

16. The apparatus as in claim 15 wherein the plurality of un-cooled ambient air ingestion ports comprise a removably attached mated filter membrane.

17. The apparatus as in claim 16 wherein the plurality of un-cooled ambient air ingestion ports comprise an upper port, a front port and an exterior lower front port.

18. The apparatus as in claim 17 wherein the exterior lower front port is removably engaged with a flexible and articulable conduit pipe leading to a front region of the vehicle.

19. The apparatus as in claim 12 wherein the ingested ambient air in funneled into the housing by way of a hollow bore conduit in flow communication with at least the plurality of ambient air ingestion inlets.

20. The apparatus as in claim 12 wherein the auxiliary air conditioning evaporator cooling device cools ambient air ingested by the plurality of air ports.

21. The apparatus as in claim 20 wherein the air ports further distribute the cooled air ambient air to a predetermined temperature.

22. The apparatus as in claim 12 wherein the auxiliary air conditioning evaporator cooling device is in flow communication with a modified air conditioner refrigerant line.

23. The apparatus as in claim 22 wherein the modified air conditioner refrigerant line is in flow communication with a low pressure line.

24. The apparatus as in claim 12 wherein the probe and thermostat device is in communication with at least to the modified air conditioner refrigerant line and the auxiliary air conditioning evaporator cooling device.

25. The apparatus as in claim 12 wherein the ingested ambient air is funneled to at least the fan through the hollow bore conduit.

26. The apparatus as in claim 12 wherein the cooled air is distributed to an air cleaner chamber prior to introduction into the point of ignition on the engine.

27. The apparatus as in claim 12 wherein the secondary cold air port is a multidirectional cold air port, the multidirectional cold air port providing for delivery of cold air from the housing to the air cleaner chamber and further allowing for air within the chamber to be extracted back into the housing from the chamber when the engine is not under a load demand condition, thereby allowing the extracted air to be further re-cooled and re-delivered to the chamber.

28. A method for providing cold air into the throttle body of a gas engine, the method comprising the steps of:
providing a gas engine having a throttle body;
providing and utilizing originally installed standard an air conditioning compressor, air conditioning condenser and accumulator/dryer of a vehicle;
providing at least one housing for containing a plurality of components that constitute a cold air induction apparatus;
providing a plurality ambient air inlet ports disposed thereon the at least one housing;
ingesting ambient air into the apparatus through the plurality of ambient air inlet ports for cooling thereof;
providing an auxiliary air conditioning evaporator cooling device;
cooling the ingested ambient air to a first predetermined temperature by way of the auxiliary air conditioning evaporator cooling device;
distributing the cooled ingested ambient air forcefully by way of a fan to an air cleaner chamber; and
forcefully providing the cooled air at a second predetermined temperature to the throttle body after filtering, thereby increasing horsepower and fuel economy and lowering emissions.

29. The method as in claim 28 wherein the cooled ingested ambient air travels through a filter prior to departing the chamber.
